(19) United States
(12) Patent Application Publication
(10) Pub. No.: US 2001/0000969 A1
(43) Pub. Date: May 10, 2001

(54) Electronic still camera and method of operating same

(76) Inventors: Tadashi Ohta, Yokohama-shi (JP); Takao Ikuma, Kawasaki-shi (JP)

Correspondence Address: Nelson H. Shapiro, Vorys, Sater, Seymour and Pease LLP, Eleventh Floor, 1828 L Street, N.W., Washington, DC, 20036-5109, US

(21) Appl. No.: 09/749,680

(22) Filed: Dec. 28, 2000

Related U.S. Application Data
(63) Continuation of application No. 09/399,150, filed on Sep. 20, 1999.
Application No. 09/399,150 is a continuation of application No. 08/914,758, filed on Aug. 20, 1997, now abandoned.
Application No. 08/914,758 is a continuation of application No. 08/410,398, filed on Mar. 27, 1995, now abandoned.
Application No. 08/410,398 is a continuation of application No. 08/253,324, filed on Jun. 3, 1994, now abandoned.
Application No. 08/253,324 is a continuation of application No. 07/802,812, filed on Dec. 6, 1991, now abandoned.

(30) Foreign Application Priority Data
Dec. 13, 1990 (JP) 2-401881

(51) Int. Cl. H04N 5/222

(52) U.S. Cl. 348/231; 348/333.02

(57) ABSTRACT

An electronic still camera, for recording the image signal in compressed state in a memory medium such as a memory card, is provided with a calculation circuit, for calculating the remaining number of still recordable frames in the memory medium in more reliable manner, and the number of already recorded frames and the remaining number of still recordable frames are simultaneously displayed in order to inform the photographer of the remaining state of the memory card in securer manner.

The remaining frame number is calculated in securer manner by detecting the remaining capacity of the memory card and dividing the remaining capacity with the amount of compressed signal averaged over the latest 100 image frames. A display device is provided for indicating thus determined remaining frame number together with the number of already recorded frames.

For calculating the remaining frame number in more reliable manner, there are determined the average data amount of the recorded frames, the standard deviation, and the remaining capacity of the memory card, and the minimum remaining frame number is determined by dividing the remaining capacity with the average data amount plus standard deviation, while the maximum remaining frame number is determined by dividing the remaining capacity with the average data amount minus standard deviation. Also there is provided a display device for indicating the remaining frame number in the form of a range defined by the minimum and maximum remaining frame numbers.

### BACKGROUND OF THE INVENTION

1. 1. Field of the Invention

2. The present invention relates to an electronic still camera capable of storing photographed still image signal in a memory medium.

3. 2. Related Background Art

4. In the conventional electronic still camera utilizing a memory medium, the storage of still image signal has been conducted with compression of said still image signal for example to about 1/10 by a suitable compression process, because the data amount of digitized still image signal is very large.

5. Also the conventional electronic still camera has only indicated the number of recorded frames, or only the remaining number of still recordable frames, by determining the data amount to be recorded in the memory medium per frame and equally dividing the total capacity of the memory medium by said data amount.

### SUMMARY OF THE INVENTION

6. However, such data compression does not necessarily give a constant data amount after compression, and, depending on the process of compression, the data amount after compression may fluctuate by about ±50% between a monotonous image and a complex image with fine definition. More specifically, if the data amount after compression per phototaking operation is 0.1 MB in average with a fluctuation of ±50% depending on the pattern of the image, said data amount will vary from 0.05 to 0.2 MB. In such case, if only the number of recroded frames is indicated, the total number of frames recordable in the memory medium varies from medium to medium, so that the photographer is unable to know the total number of frames recordable in the memory medium. A similar drawback occurs in case of using a memory medium of different total capacity. On the other hand, if indication of only the remaining number of recordable frames is intended wihtout determination of data amount per frame to be recorded in the memory medium, an exact remaining number cannot be indicated because the data amount fluctuates from frame to frame. An object of the present invention, therefore, is to resolve the above-mentioned drawback in the conventional indication system and to securely inform the photographer of the remaining state of the memory medium after a phototaking operation, by simultaneously indicating the number of already taken frames and the number of still recordable frames or remaining capacity.

7. Also when the capacity allocation per frame is fixed in the memory medium, all the taken information cannot be recorded if the data amount after compression is larger than said allocated capacity, and the capacity of the memory medium cannot be fully utilized if the data amount after compression is smaller than said allocated capacity. It is therefore more efficient to record the compressed data for each phototaking operation, without determining the allocated capacity per frame. For this reason the indication of the remaining recordable frames has to be of a higher reliability. Another object of the present invention, therefore, is to resolve the above-mentioned drawback of the conventional indication system and to provide an indication of remaining number of recordable frames with higher reliability, by means of calculation means.

8. The above-mentioned objects can be attained, according to the present invention, by an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, calculation means for determining the remaining number of still recordable frames by dividing the remaining capacity of the memory medium with amount of compressed signal corresponding to a frame, and display means for indicating the number of already recorded image frames and said remaining number of recordable images.

9. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, calculation means for determining the remaining number of still recordable frames by dividing the remaining capacity of the memory medium with amount of compressed signal corresponding to a frame, and display switching means capable of selecting either the indication of said remaining number of still recordable frames or the indication of the remaining capacity of said memory medium.

10. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, calculation means for determining the remaining number of still recordable frames by dividing the remaining capacity of the memory medium with amount of compressed signal corresponding to a frame, and display means including a first display part for indicating the number of already recorded frames and a second display part of belt form surrounding said first display part, wherein a range of said second display part corresponding to said remaining number of recordable frames is lighted, whereby the number of already recorded frames and the remaining number of recordable frames are indicated.

11. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting the amount of compression signal of latest frames of a predetermined number from said memory means, calculation means for determining the average amount of signal in the frames of said predetermined number and determining the remaining number of recordable frames by dividing the remaining capacity of the memory medium with said average signal amount or with said average signal amount increased by a predetermined proportion, and display means for indicating said remaining number of recordable frames.

12. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting, from the memory means, the amount of compressed signal of frames recorded in said memory medium, calculation means for determining the average signal amount per frame on thus extracted frames and determining the remaining number of recordable frames by dividing the remaining capacity of the recording medium with said average signal amount or with said average signal amount increased by a predetermined proportion, and display means for indicating said remaining number of recordable frames.

13. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting the maximum amount of latest compression signals from said memory means, calculation means for determining the remaining number of recordable frames by dividing the remaining capacity of the memory medium with said maximum signal amount, and display means for indicating said remaining number of recordable frames.

14. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, calculation means for determining the remaining number of recordable frames by dividing the remaining capacity of the memory means with a predetermined amount, and display means for indicating said remaining number of recordable frames.

15. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, calculation means for determining the remaining number of recordable frames by dividing the remaining capacity of the memory medium with the amount of said compressed signal in a latest phototaking operation, and display means for indicating said remaining number of recordable frames.

16. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting the maximum and minimum amounts of the compressed signals from said memory means calculation means for determining minimum and maximum remaining numbers of recordable frames by dividing the remaining capacity of the recording medium respectively with said maximum and minimum signal amounts, and display means for indicating said remaining number of recordable frames by a range of which minimum and maximum values respectively correspond to said minimum and maximum remaining number of recordable frames.

17. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting the maximum amount, minimum amount and approximate average amount of the compressed signals from said memory means, calculation means for dividing the remaining capacity of the memory medium with said maximum or minimum amount or said approximate average amount thereby determining a respectively corresponding remaining number of recordable frames, selection means for manually selecting said maximum, minimum or approximate average amount of the compressed signal, and display means for indicating said selected minimum, maximum or approximate average amount of the compressed signal and the remaining number of recordable frames corresponding to thus selected compressed signal.

18. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, extraction means for extracting the amount of compression signal of latest frames of a predetermined number from said memory means, calculation means for calculating the average signal amount of frames of said predetermined number and the standard deviation of said signal amount, and determining the minimum remaining number of recordable frames by dividing the remaining capacity of the memory medium with the sum of said average amount and said standard deviation increased by a predetermined proportion and the maximum remaining number of recordable frames by dividing the remaining capacity of the memory medium with said average amount from which subtracted is said standard deviation increased by a predetermined proportion, and display means for indicating said remaining numbers of recordable frames.

19. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, start signal input means for manually entering an average calculation start signal, extraction means for extracting, from said memory means, the amount of compressed signal of the frames after the entry of the calculation start signal by said input means, calculation means for calculating the average signal amount of said frames and determining the remaining number of recordable frames by dividing the remaining capacity of the memory medium with said average signal amount, and display means for indicating said remaining number of recordable frames.

20. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, start signal input means for manually entering an average calculation start signal, extraction means for extracting, from said memory means, the amount of compressed signal of the frames after the entry of the calculation start signal by said input means, calculation means for calculating the average signal amount of said frames and the standard deviation thereof, and determining the minimum remaining number of recordable frames by dividing the remaining capacity of the memory medium with said average signal amount to which added is said standard deviation increased by a predetermined proportion, and the maximum remaining number of recordable frames by dividing the remaining capacity of the memory medium with said average signal amount from which subtracted is said standard deviation increased by a predetermined proportion, and display means for indicating said remaining numbers of recordable frames.

21. The present invention also provides an electronic still camera capable of A/D conversion of still image signal obtained from an image pickup device and compression of thus digitized signal, and provided with a memory medium capable of recording thus compressed signal plural times, comprising detection means for detecting the remaining capacity of said memory medium, memory means for memorizing the amount of said compressed signal for each phototaking operation, calculation means for determining the remaining number of recordable frames by dividing the remaining capacity of the memory medium with a predetermined signal amount until a predetermined number of frames, and, beyond said number, calculating the average signal amount of the frames recorded in said memory medium and the standard deviation thereof and determining the minimum remaining number of recordable frames by dividing the remaining capacity of the recording medium with said average signal amount to which added is said standard deviation increased by a predetermined proportion and the maximum remaining number of recordable frames by dividing the remaining capacity of the recording medium with said average signal amount from which subtracted is said standard deviation increased by a predetermined proportion, and display means for indicating said remaining number(s) of recordable frames.

22. The present invention also provides an electronic still camera capable of A/D conversion of still image signal obtained from an image pickup device and compression of thus digitized signal, and provided with a memory medium capable of recording thus compressed signal plural times, comprising compression rate selection means for selecting one of plural compression rates with which said digitized signal is compressed, detection means for detecting the remaining capacity of said memory medium, memory means for memorizing the amount of said compressed signal and the compression rate for each phototaking operation, extraction means for extracting the maximum and minimum amounts of the compressed signal for each compression rate from said memory means, calculation means for determining the minimum and maximum remaining numbers of recordable frames for each compression rate by dividing the remaining capacity of the memory medium respectively with said maximum and mimimum signal amounts, and display means for indicating the remaining number of recordable frames by a range of which minimum and maximum values correspond to those of said remaining number of recordable frames in the currently selected compression rate.

23. The present invention also provides an electronic still camera capable of A/D conversion of still image signal obtained from an image pickup device and compression of thus digitized signal, and provided with a memory medium capable of recording thus compressed signal plural times, comprising compression rate selection means for selecting one of plural compression rates with which said digitized signal is compressed, detection means for detecting the remaining capacity of said memory medium, memory means for memorizing the amount of said compressed signal and the compression rate for each phototaking operation, extraction means for extracting, from said memory means, the maximum and mininum amounts of latest compression signals for each compression rate, calculation means for determining the minimum and maximum remaining numbers of recordable frames for each compression rate by dividing the remaining capacity of the memory medium respectively with the maximum and minimum signal amounts, and display means for indicating the minimum and maximum remaining numbers of recordable frames of the currently selected compression rate.

24. As described above, the present invention allows to correctly inform the photographer of the status of use of the memory medium, even in case of fluctuation of the data amount after compression because of the pattern of the frames, as the number of recorded image frames and the remaining number of recordable image frames are displayed at the same time.

25. Also the present invention enables to indicate the remaining number of recordable image frames to the photographer in an easily understandable visual manner.

26. Also the present invention is capable of indicating the highly reliable remaining number of recordable image frames.

27. Naturally, the number of recorded image frames and the remaining number of still recordable image frames need not necessarily be always displayed together, but either one only may be indicated depending upon the case.

28. Also the present invention allows the photographer to know the remaining state of the memory medium after a phototaking operation.

29. Also the present invention is capable of informing the photographer of the remaining number of recordable image images in the memory medium, after a phototaking operation, in the form of a range from a minimum number to a maximum number.

30. Also the present invention enables the photographer to observe selectively the images with minimum, maximum and approximately average amounts of compressed data, among image frames recorded by photographer himself, and is capable of informing the remaining number of recordable image frames in the memory medium after a phototaking operation, based on the selected image.

31. Also the present invention is capable of informing the photographer with the remaining number of recordable image frames with a safety margin.

32. Also the present invention is capable of informing the photographer of the remaining number of recordable image frames in the memory medium, in case the purpose or intention of the photographer changes.

33. Also the present invention is capable of informing the photographer of the remaining status of the memory medium after a phototaking operation, thereby enabling the photographer to effect phototaking operations adapting to said remaining status.

### BRIEF DESCRIPTION OF THE DRAWINGS

34. FIG. 1 is an external view of an electronic still camera;

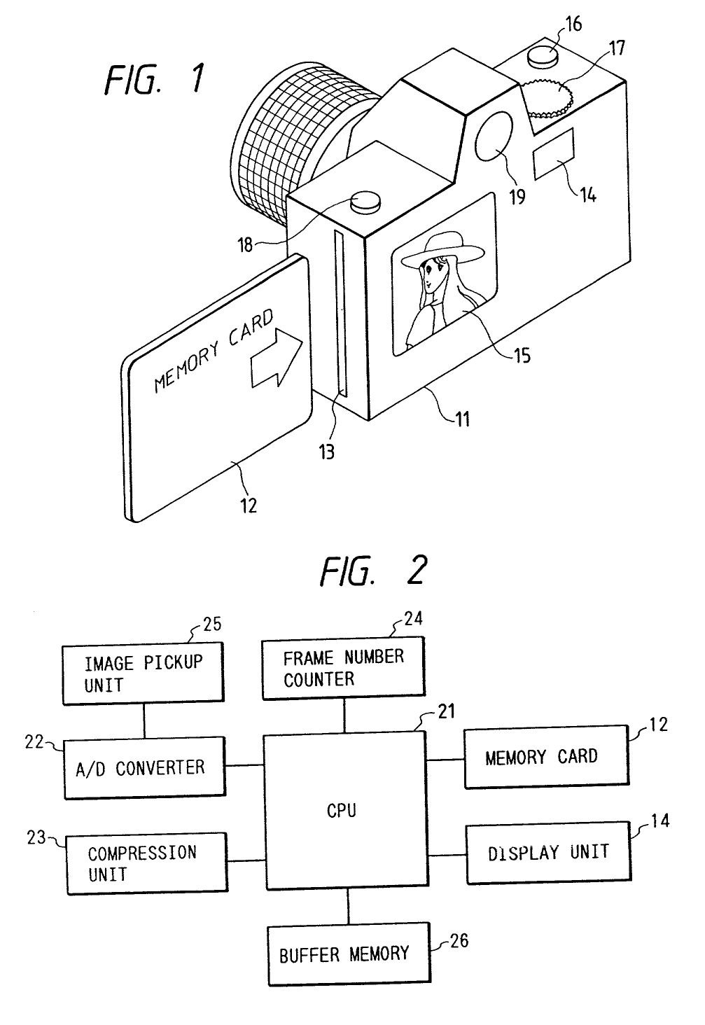

35. FIG. 2 is a block diagram thereof;

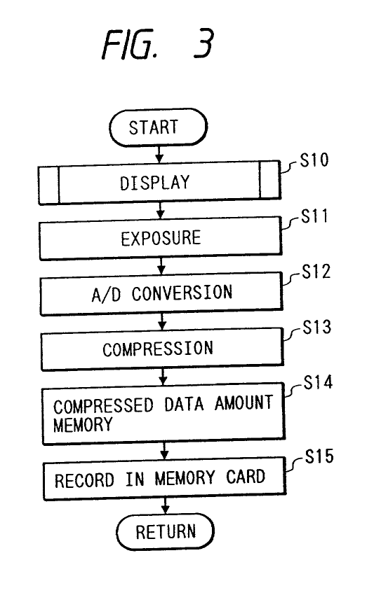

36. FIG. 3 is a flow chart of a control sequence by a CPU 20;

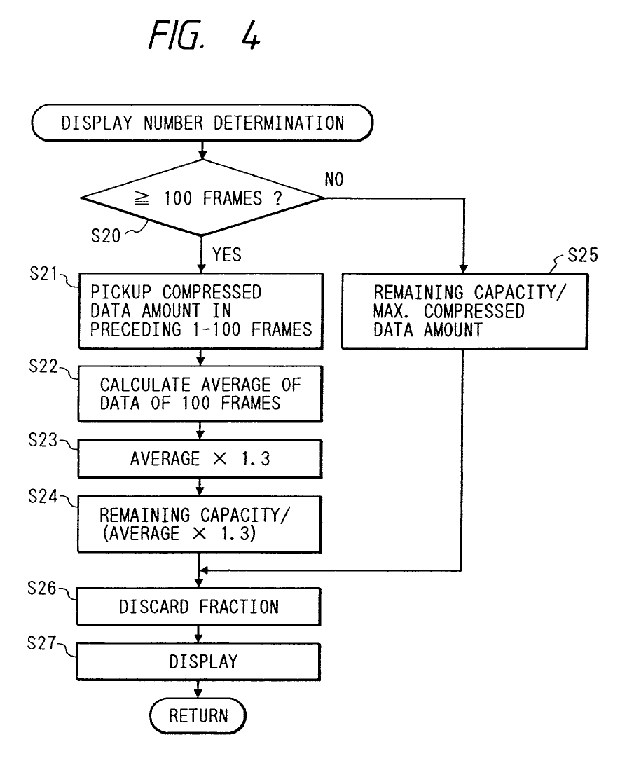

37. FIGS. 4 to 6 are flow charts of a subroutine in a step S10 in FIG. 3, constituting 1st to 3rd embodiments of the present invention;

38. FIG. 7 is a schematic view showing, as a 6th embodiment, the method of display of a display unit 14 shown in FIG. 1;

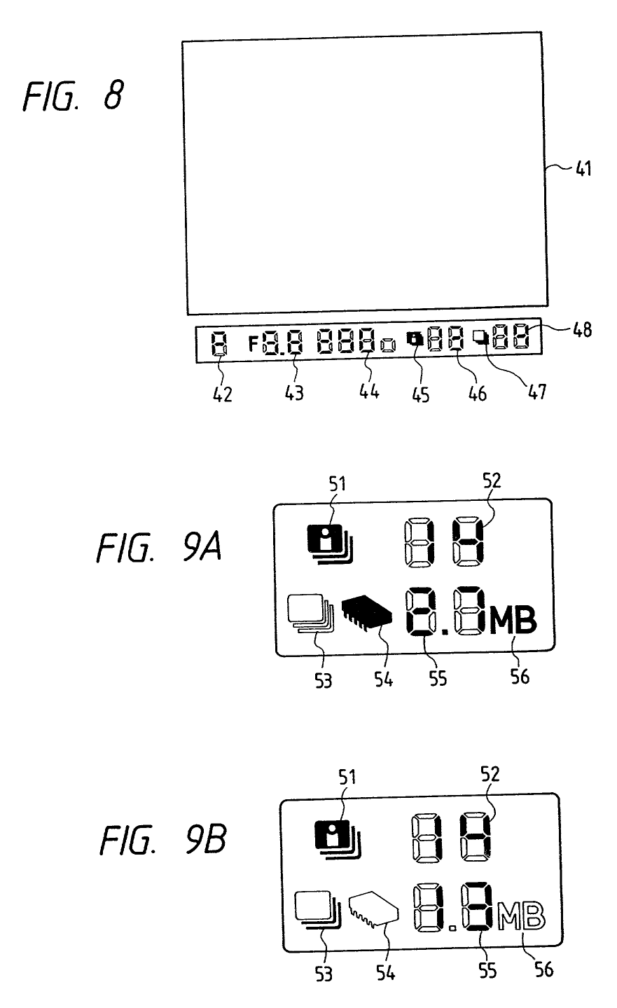

39. FIG. 8 is a schematic view showing, as a 7th embodiment, the method of display in a view finder 19 shown in FIG. 1;

40. FIGS. 9A and 9B are schematic views showing as an 8th embodiment, another method of display of the display unit 14 shown in FIG. 1;

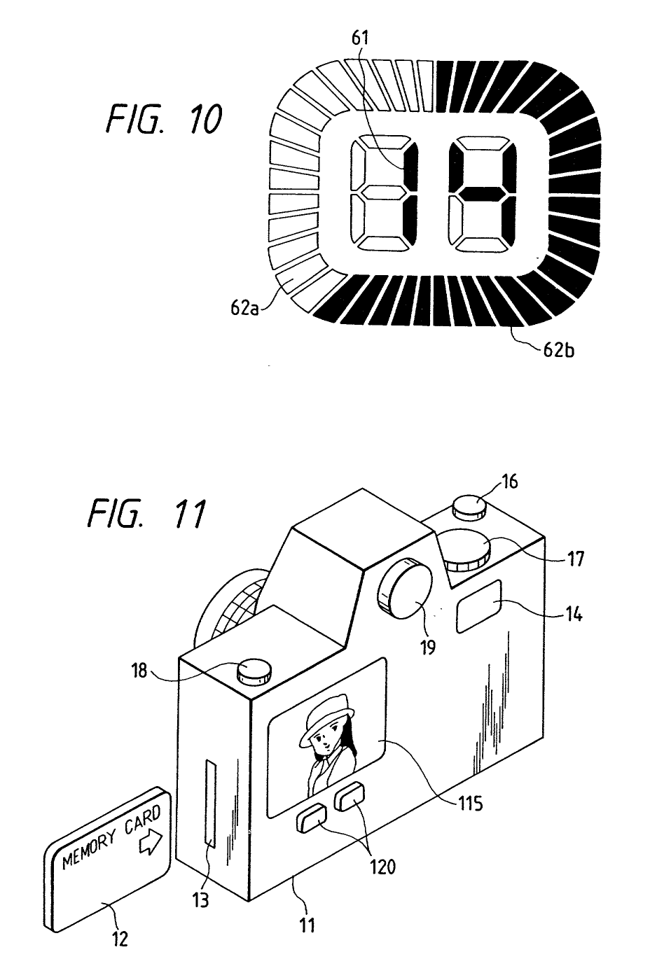

41. FIG. 10 is a schematic view showing, as a 9th embodiment, the method of display in a display unit 14 shown in FIG. 1;

42. FIG. 11 is an external view showing, as a 10th embodiment, an electronic still camera;

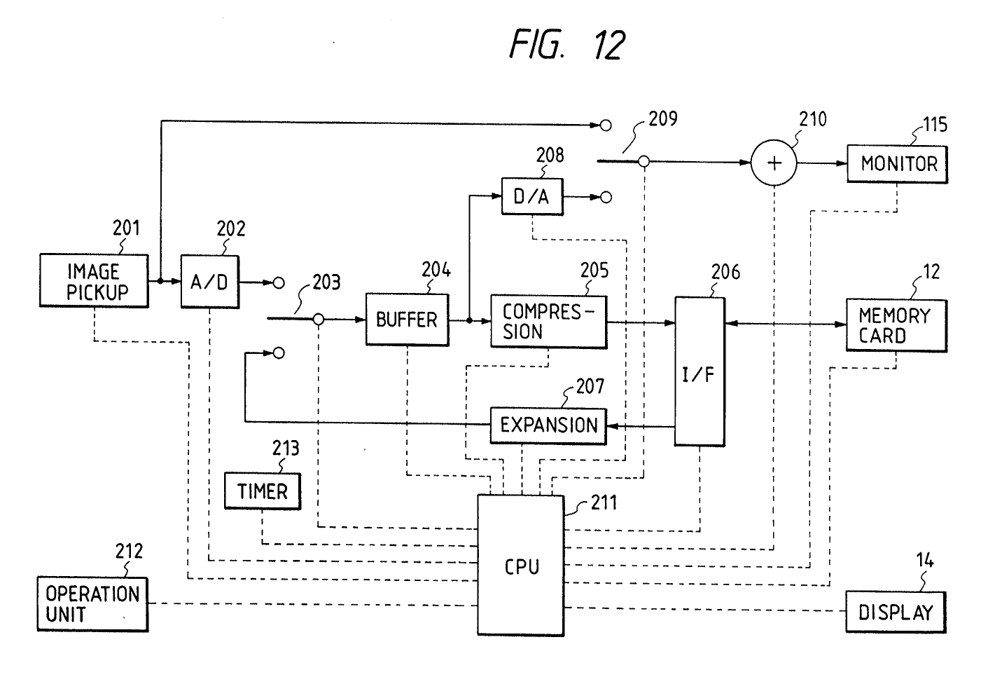

43. FIG. 12 is a block diagram of the electronic still camera shown in FIG. 11;

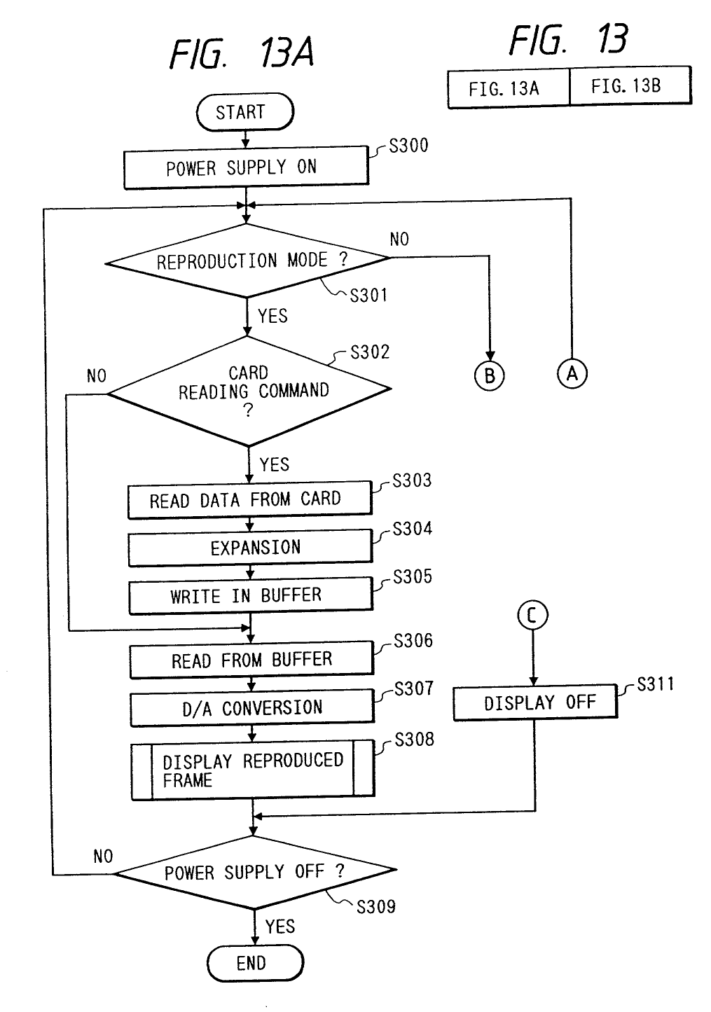

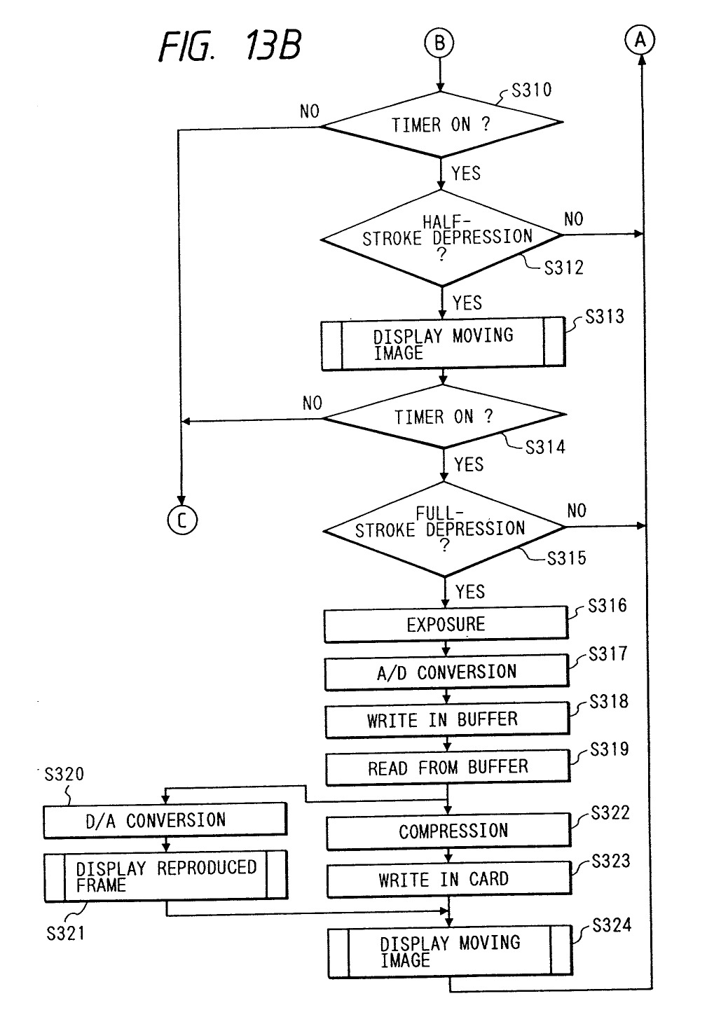

44. FIGS. 13 to 15 are flow charts of the control sequence by a CPU 211;

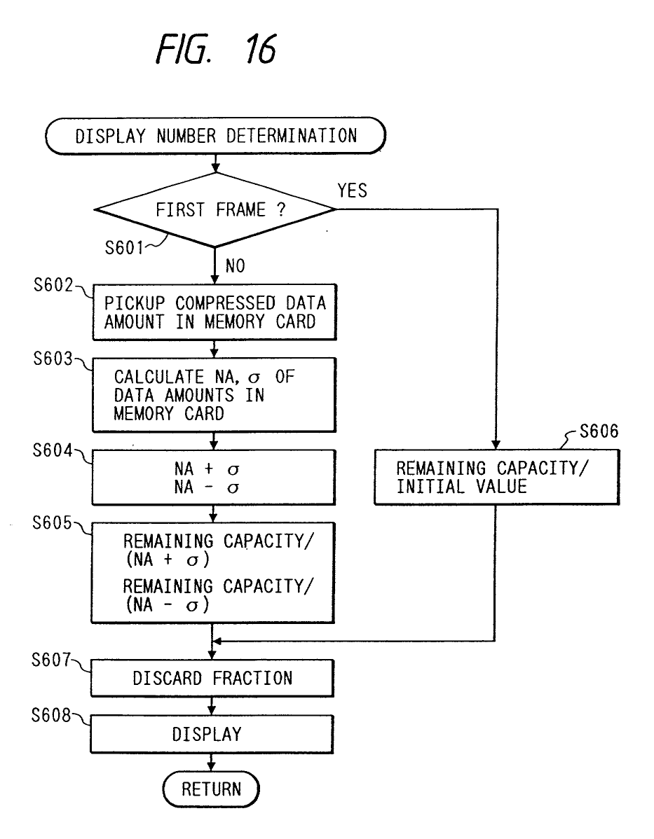

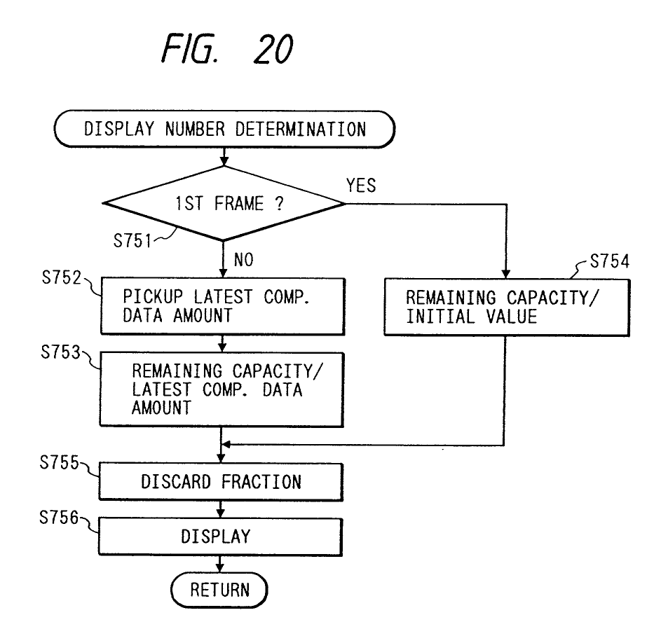

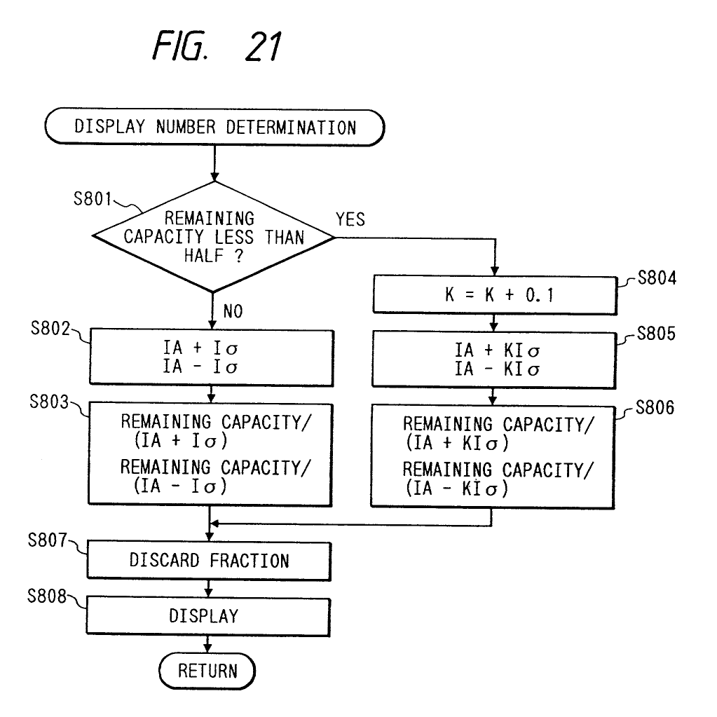

45. FIGS. 16 to 21 are flow charts, showing, as 11th to 16th embodiments, control sequences for calculating the remaining number of recordable frames; and

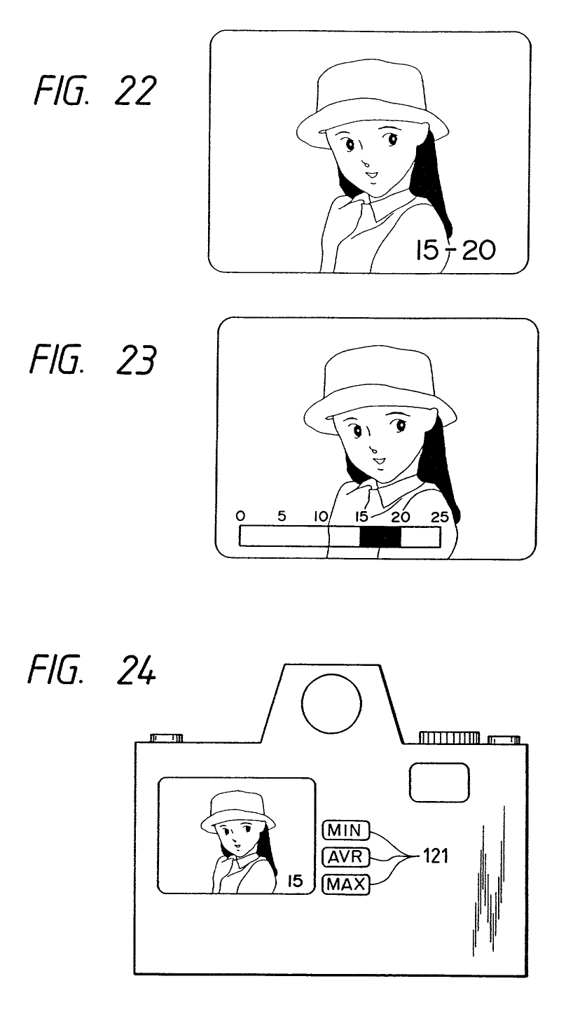

46. FIGS. 22 to 24 are schematic views showing, as 17th to 18th embodiments, methods of display in a display unit 115 shown in FIG. 11.

### DESCRIPTION OF THE PREFERRED EMBODIMENTS

47. Now the present invention will be clarified in detail by preferred embodiments thereof shown in the attached drawings.

48. FIG. 1 is an external view of an electronic still camera of the present invention.

49. Referring to FIG. 1, a main body of the electronic still camera is provided with a slot 13 into which inserted is a memory card 12 constituting the memory medium for storing image data supplied from the main body. A display unit 14 provided on the rear face of the main body 11 displays the number of already recorded frames and the remaining number of still recordable frames or the remaining capacity. The method of determining the displayed remaining number will be detailedly explained later. Another liquid crystal display unit 15 is used for displaying the contents of the memory card 12 or as an electronic view finder. The exposure operation of the camera is initiated by a shutter release button 16. A mode setting dial 17 is usually used for setting a shutter time or an aperture of the diaphragm of the phototaking lens, but can also be used for switching the displayed content of the display unit 15, when rotated while a selector button 18 is depressed. Also an optical view finder 19 is provided in the upper part of the main body.

50. The number of recorded frames and the remaining number of recordable frames may also be displayed on the display unit 15 in overlapping manner with the image displayed therein, instead of display in the display unit 14.

51. Also the display unit 15 may be used normally for displaying a designated image among those recorded in the memory card 12, but as an electronic view finder when the shutter release button 16 is depressed by a half stroke.

52. FIG. 2 is a block diagram of the present electronic still camera, provided with a CPU 21, an A/D converter 22, a compression unit 23, a memory card 12, a display unit 14, a recorded frame number counter 24, an image pickup unit 25, and a buffer memory 26.

53. FIG. 3 is a flow chart showing the basic control sequence by the CPU 21.

54. At first, when the power supply is turned on, a step S10 displays the number of recorded image frames and the remaining number still recordable image frames, on the display unit. The method for determining said displayed remaining number will be explained later.

55. A step S11 effects exposure of the image pickup unit 25, in response to the depression of the shutter release button 16.

56. In a step S12, the A/D converter 22 digitizes the still image signal obtained by said exposure.

57. A step S13 compresses the digitized signal in the compression unit 23.

58. Then a step S14 accumulates the compressed data in the buffer memory 26 and memorizes the amount of said compressed data.

59. A step S15 records the compressed data of the buffer memory 26 in the memory card 12, and the sequence of the present flow chart is terminated.

60. FIG. 4 is a flow chart of a first embodiment of the control sequence for determining the remaining number of recordable frames, used in the step S10 shown in FIG. 3.

61. The present embodiment is based on a fact that the objects taken by individual photographer often show certain personal characteristics. Stated differently, the images taken by a photographer often contain many similar situations. For example, some photographers preferentially record certain landscape such as sunset on ocean horizon, while others record certain sports. Thus there is utilized a fact that the amount of compressed data per frame becomes almost constant. The average data amount after compression, per image frame for a photographer is calculated from the data of recently taken 100 frames of said photographer, and said average value is increased by 30% for providing a safety margin in the displayed number. Thus, an integer, obtained by dividing the remaining capacity of the memory card with said increased average value, is displayed as an estimated number of still recordable image frames for said photographer. Said data of 100 frames are always renewed and latest data are used for calculating the average value.

62. In the following the flow chart of the present subroutine will be explained step by step.

63. A step S20 discriminates whether the number of image frames already recorded by the present still camera is at least equal to 100. This is because the average calculation utilizes 100 frames, but the number of frames is not limited to 100 and can be arbitrarily selected as a number at least equal to 2. The sequence proceeds to a step S21 or S25 respectively if said number is at least equal to 100 or less than 100.

64. Then a step S21 extracts the amount of compressed data, for the latest 100 frames, already accumulated in the step S14 in FIG. 3.

65. A next step S22 calculates the average value, from thus extracted amount of compressed data of 100 frames.

66. A next step S23 increases the calculated average by 30%. This is to provide a certain safety margin, by displaying a smaller remaining number of recordable image frames, rather than giving an erroneous expectation to the photographer by displaying a larger number, and the amount of said increase is not limited to 30%.

67. A next step S24 calculates the estimated remaining number of recordable frames by dividing the remaining capacity of the memory card with said increased average value. Subsequently the sequence proceeds to a step S26.

68. On the other hand, in case the number of recorded frames is less than 100, a step S25 calculates a value, as the substitute for the estimated remaining number of recordable frames, by dividing the remaining capacity of the memory card with a predetermined maximum amount of compressed data (0.2 MB explained in the Related Background Art), and the sequence then proceeds to the step S26.

69. The step S26 discards the fractional part of the value calculated in the step S24 or S25, in order to obtain an integral number for display. Said discarding operation is also for giving a safety margin to the displayed number, and may be replaced by a rounding operation.

70. A next step S27 displays, on the display unit 14, thus obtained integral value as the estimated remaining number of recordable image frames for the individual photographer, and the present subroutine is then terminated.

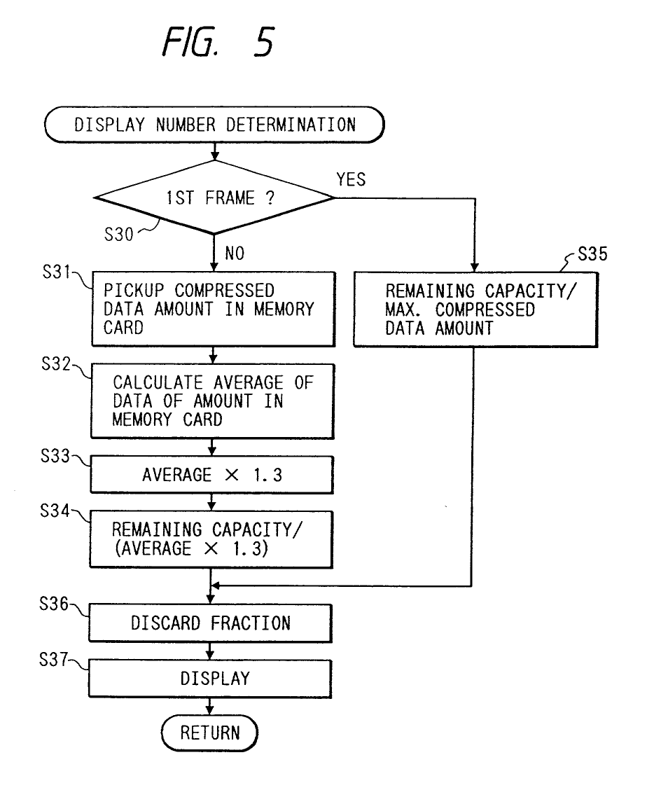

71. FIG. 5 is a flow chart of a 2nd embodiment of the control sequence for determining the remaining number of recordable frames, in the step S10 in FIG. 1.

72. This embodiment is based on a fact that similar objects are often recorded in consecutive manner, and consists of calculating the average of compressed data amount from all the data recorded in the memory card currently in use, then increasing said average by 30% as in the 1st embodiment, and displaying the integral value, obtained by dividing the remaining capacity with said increased average, as the estimated remaining number of recordable frames for the current memory card.

73. The flow chart of the present subroutine will be explained in the following, step by step.

74. At first a step S30 discriminates whether the next phototaking operation is for the first frame in the currently used memory card. This is because said average calculation employs at least one frame. If there are employed at least two frames, said step discriminates whether the next phototaking operation is for the second frame. Then the sequence proceeds to a step S31 or S35, respectively if the next phototaking operation is at least for the 2nd frame, or for the 1st frame.

75. Then a step S31 extracts the amount of compressed data, for all the frames stored in the memory card, accumulated by the step S14 in FIG. 3, and a step S32 calculates the average from thus extracted compressed data amount of all the frames.

76. A next step S33 increases the calculated average by 30%, for the same reason as in the 1st embodiment.

77. A next step S34 calculates the estimated remaining number of recordable image frames, by dividing the remaining capacity of the memory card with said increased average, and the sequence then proceeds to a step S36.

78. On the other hand, in case there is no recorded frame and the next phototaking operation is for the first frame, a step S35 calculates a value, as a substitute for the estimated remaining number of recordable frames, by dividing the remaining capacity of the memory card with a predetermined maximum amount of compressed data (0.2 MB explained before).

79. A next step S36 discards the fractional part of the value calculated in the step S34 or S35, in order to obtain an integral value for display, as in the 1st embodiment.

80. A next step S37 displays, on the display unit 14, thus obtained integral value as the estimated remaining number of recordable image frames for the current memory card, and the present subroutine is then terminated.

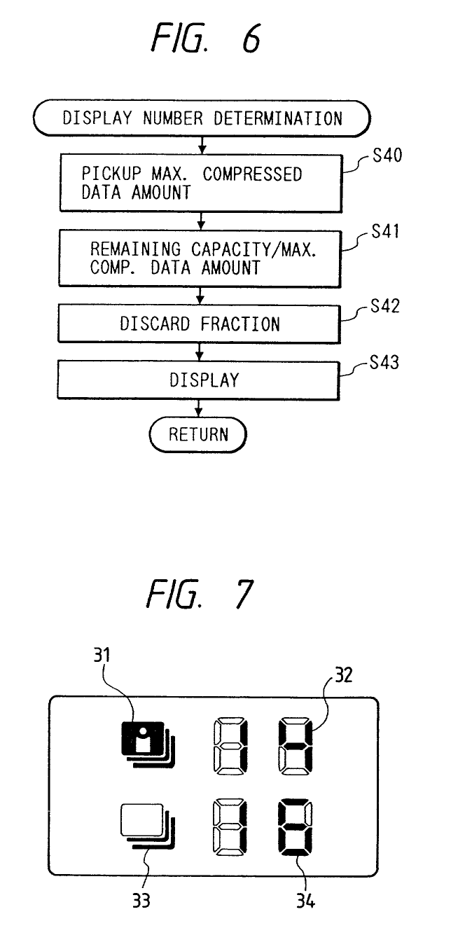

81. FIG. 6 is a flow chart of a 3rd embodiment of the subroutine for determining the remaining number of recordable frames, in the step S10 in FIG. 3.

82. The present embodiment adopts the estimated minimum value as the remaining number of recordable frames, for giving emphasis on the safety margin, and displays an integral value, obtained by dividing the remaining capacity of the memory card with the maximum data amount per frame, among the already recorded compressed data, as the minimum remaining number of recordable frames. Said maximum data amount is renewed to the latest one.

83. The flow chart of the present subroutine will be explained in the following, step by step.

84. At first a step S40 extracts the maximum data amount per frame, from the compressed data already accumulated by the step S14 in FIG. 3.

85. A next step S41 calculates a value by dividing the remaining capacity of the memory card with thus extracted maximum amount of compressed data.

86. A next step S42 discards the fractional part of thus calculated value, in order to obtain an integral value for display, as in the 1st embodiment.

87. A next step S43 displays, on the display unit 14, thus obtained integral value as the minimum remaining number of recordable frames, and the present subroutine is then terminated.

88. A 4th mebodiment of the control sequence for determining the remaining frame number in the step S10 in FIG. 3, displays the remaining capacity of the memory card 12 in the unit of MB. The corresponding flow chart of this embodiment is not shown in the attached drawings.

89. A 5th embodiment of the control sequence for determining the remaining frame number in the step S10 in FIG. 3 consists of dividing the remaining capacity with a predetermined minimum copressed data amount (0.05 MB explained before) and displaying an integer, obtained by raising the fractional part, as the maximum remaining number of recordable frames.

90. The display on the display unit 14 can be made with one of the foregoing 1st to 5th embodiments, or can also be made selectable from two or more determining sequences.

91. FIG. 7 illustrates, as a 6th embodiment, a display method of the display unit 14 shown in FIG. 1. FIG. 7 shows an arrangement including paired seven-segment elements 32 for indicating the number of already recorded frames in a two-digit number; a symbol mark 31 to be turned on for indicating that the seven-segment elements 32 indicate the number of recorded frames; paired seven-segment elements 34 for indicating the remaining number of recordable frames in a two-digit number; and a symbol mark 33 to be turned on for indicating that the seven-segment elements 34 indicate the remaining number of recordable frames. Said remaining number in this embodiment is determined according to the 1st embodiment explained above.

92. FIG. 8 illustrates, as a 7th embodiment, a method of displaying the number of recorded frames and the remaining number of recordable frames, together with other displays, in the view finder 19 shown in FIG. 1.

93. Under an image field frame 41, there are arranged, from left to right, a mode display unit 42 for indicating the phototaking mode of the still camera such as P (program mode), A (aperture preferential mode), S (shutter speed preferential mode) etc.; a diaphragm aperture display unit 43; and a shutter time display unit 44. In succession there are provided paired seven-segment elements 46 for indicating the number of recorded frames in a two-digit number; a symbol mark 45 to be lighted for indicating that the seven-segment elements 46 indicate the number of recorded frames; paired seven-segment elements 48 for indicating the remaining number of recordable frames in a two-digit number; and a symbol mark 47 to be lighted for indicating that the seven-segment elements 48 indicate the remaining number of recordable frames. FIG. 8 illustrates a case with a program phototaking mode, a diaphragm aperture of F5.6, a shutter time of 1/250 seconds, 13 recorded frames and 14 frames still recordable. The remaining number of recordable frames is determined according to the foregoing 2nd embodiment.

94. FIGS. 9A and 9B illustrate, as an 8th embodiment, a display method in the display unit 14 shown in FIG. 1.

95. This embodiment can switch the display of the remaining state of the memory card 12 either in (A) remaining capacity, or (B) remaining number of recordable frames, according to the selection by the photographer.

96. FIGS. 9A and 9B show an arrangement of paired seven-segment elements 52 for indicating the number of recorded frames in a two-digit number, illustrating a case of 14 recorded frames; a symbol mark to be lighted for indicating that the seven-segment elements 52 indicate the number of recorded frames; paired seven-segment elements 55 for indicating the remaining number of recordable frames or the remaining recordable capacity in a two-digit number; a symbol mark 53 to be lighted in case said elements 55 indicate the remaining frame number; a symbol mark 54 to be lighted in case said elements 55 indicate the remaining recordable capacity; and a symbol mark 56 for indicating the unit of said capacity, to be lighted simultaneously with the symbol mark 54. The display of the remaining frame number or the remaining capacity is switched by the rotation of the setting dial 17, with depression of the selector button 18.

97. FIG. 9A shows a state indicating that the remaining recordable capacity is 2.7 MB, by the marks 54, 56 and the elements 55.

98. FIG. 9B shows a state indicating that 13 frames are remaining, by the mark 53 and the elements 55.

99. In the present embodiment, the remaining recordable capacity is determined according to the foregoing 4th embodiment, and the remaining number of recordable frames is determined according to the foregoing 3rd embodiment.

100. Also there may be additionally selected the display of number of recorded frames only, or of remaining frame number or remaining capacity only, by the rotation of the setting dial 17.

101. FIG. 10 illustrates, as a 9th embodiment, a display method of the display unit 14 shown in FIG. 1.

102. There are provided paired seven-segment elements 61 for indicating the number of recorded frames in a two-digit number, and single-segment elements 62a, 62b serving to indicate the remaining number of recordable frames and so positioned as to surround said seven-segment elements 61. A single-segment portion 62a corresponding to the remaining number is lighted, while the remaining portion 62b is turned off. For each phototaking operation, the number of the seven-segment elements 61, indicating the number of recorded frames, is stepwise increased by one, while the single segments 62b, positioned therearound and indicating the remaining frame number, are in succession turned off anticlockwise. In this manner the remaining number of recordable frames can be presented to the photographer in a visually easily understandable way. The remaining frame number in the present embodiment is determined according to the foregoing 5th embodiment.

103. In the following there will be given a detailed explanation on a 10th embodiment of the electronic still camera of the present invention.

104. FIG. 11 is an external view of an electronic still camera constituting an 11th embodiment of the present invention, wherein components equivalent in function to those in FIG. 1 are represented by same numbers and are omitted from the following explanation.

105. A display unit 115 composed for example of a liquid crystal display device and positioned on the rear face of the main body 11 of the camera is used for indicating the contents of the memory card 12 or as an electronic view finder. Also on said rear face provided is an up-down button 120 to be used in reproducing of the image of the memory card 12 on the display unit 115 or searching the image of said memory card 12.

106. The display on the display unit 115 can provide, for example, a reproduction mode for displaying designated one among the still images recorded in the memory card 12 and a moving image mode for displaying a moving image as the electronic view finder, said modes being selectable by the rotation of the setting dial 17 with the depression of the selector button 18.

107. FIG. 12 is a block diagram of the present still camera, wherein solid-lined arrows indicate the flow of image signal, and broken lines indicate the transmission paths of control signals of a CPU 211.

108. An analog image signal, generated by an image pickup unit 201 composed for example of a phototaking lens, a diaphragm, a shutter, a CCD, a signal processing circuit etc., is converted by an A/D converter 202 into a digital signal, which is recorded through a selector switch 203 in a buffer memory 204. Beyond said buffer memory 204, the flow of the image signal is branched into two paths. In one of said two paths, the image signal is guided through a compression circuit 205 and an interface circuit 206 and stored in the memory card 12. In the other path, the image signal is guided through a D/A converter 208, a selector switch 209 and adding circuit 210 and displayed on an LCD monitor 115. Also the compressed image signal in the memory card 12 is supplied through the interface circuit 206, expanded in an expanding circuit 207, further guided through the selector switch 203, D/A converter 208, selector switch 209 and adding circuit 210 and displayed on the LCD monitor 115.

109. The LCD monitor 115 also displays characters and symbols generated in the CPU 211 in overlapping with the image signal, by means of the adding circuit 210. This overlapping display will be explained later.

110. Said characters and symbols can also be displayed on the display unit 14.

111. In case the LCD monitor 115 is used as an electronic view finder, the image signal from the image pickup unit 201 is supplied thereto through the selector switch 209 and adding circuit 210.

112. The CPU 211 also receives various manual input signals from an operation unit 212 including the shutter release button 16, setting dial 17, selector button 18, up-down button 120 etc. The CPU 211 is equipped with a timer for measuring, after a manual input operation, the time for enabling a next manual operation. Controls signals of the CPU 211, generated in response to various manual input signals from said operation unit 212, control the functions of the image pickup unit 201, A/D converter 202, selector switch 203, buffer memory 204, compression circuit 205, interface circuit 206, expansion circuit 207, D/A converter 208, selector switch 209, adding circuit 210, LCD monitor 115, memory card 12 and display unit 14.

113. In the following there will be explained the writing of image signal into the memory card 12 and reading of image signal therefrom, and the image display on the display unit 115 under the control of the CPU 211, with reference to a flow chart shown in FIG. 13. It is assumed that the memory card 12 is inseted into the main body 11 and is not extracted therefrom.

114. At first, when an unrepresented power switch is turned on in a step S300, the CPU 211 is powered and the sequence proceeds to a step S301.

115. The step S301 discriminates whether the display mode of the LCD monitor 115 is the reproduction mode, and the sequence proceeds to a step S302 or S310 respectively if the reproduction mode is selected or not.

116. Then the step S302 discriminates whether or not to read the image data from the memory card 12. The sequence proceeds to a next step S303 for image data reading, if the reproduction mode is selected for the first time after the start of power supply, or if the display mode is switched from the moving image mode to the reproduction mode while the power supply is on, or if the up-down button 120 is actuated. If none of these conditions are met, the expanded image data are already stored in the buffer memory 204, so that the sequence proceeds to a step S306.

117. The step S303 reads the compressed image data from the memory card 12 through the interface circuit 206.

118. A next step S304 expands the read image data, and a step S305 stores the expanded image data through the selector switch 203 into the buffer memory 204.

119. A step S306 reads the expanded image data from the buffer memory 204, then a step S307 effects D/A conversion, and a step S308 displays the reproduced still image on the LCD monitor 115 through the selector switch 209 and the adding circuit 210.

120. Thereafter the sequence returns to the step S301 and continues the reproduction of the image, selected by the up-down button 120, on the LCD monitor 115, unless the power supply is turned off in a step S309.

121. On the other hand, if the step S301 identifies that the moving image mode is selected for the display, the sequence proceeds to a step S310.

122. The step S310 discriminates whether a timer 213 is in function. If a predetermined time of the timer 213 expires without any actuation of the shutter release button 16, no display is conducted on the LCD monitor 115, and the sequence proceeds to a step S311.

123. The sequence passes through said step S311, since there is no display in this state, and proceeds to the aforementioned step S309.

124. On the other hand, if said step S310 identifies that the timer is in function, the sequence proceeds to a step S312.

125. The step S312 discriminates whether the shutter release button 16 is depressed by a half stroke, and, if depressed, the sequence proceeds to a next step S313, but, if not, the sequence returns to the step S301 for awaiting a change in the display mode.

126. The step S313 displays the image signal, obtained from the image pickup unit 201, on the LCD monitor 115 through the selector switch 209 and adding circuit 210, thereby causing said monitor 115 to function as the electronic view finder.

127. A next step S314 discriminates whether the timer 213 is in function. If a predetermined time of the timer 213 expires without full-stroke depression of the shutter release button 16, the sequence proceeds to a step S311 for turning off the display on the LCD monitor 115. If the timer 213 is identified to be in function, the sequence proceeds to a step S315.

128. The step S315 discriminates whether the shutter release button 16 is depressed by the full stroke, and, if depressed, the sequence proceeds to a next step S316, but, if not, the sequence returns to the step S301 for awaiting a change in the display mode.

129. In case the sequence proceeds to the step S316 in response to the full-stroke depression of the shutter release button in the course of function of the timer 213, there is initiated a phototaking operation. More specifically, a step S316 exposes the CCD, a step S317 effects A/D conversion, a step S318 records the image signal in the buffer memory 204, and a step S319 reads the image signal recorded in the step S319 in the buffer memory 204.

130. Thereafter the image signal flows along two paths. In one path, the image signal is displayed on the LCD monitor 115 in steps S320-S321. In the other, the image signal is stored in the memory card in steps S322-S323.

131. In the display path, a step S320 effects D/A conversion on the image stored in the buffer memory 204, and a step S321 displays the image what has just been taken as a still image on the LCD monitor 115, through the selector switch 209 and the adding circuit 210. The duration of display of said still image need only to be enough for allowing the photographer to confirm the recorded image, in consideration of the case of continuous phototaking operations.

132. In the other recording path, a step S322 compresses the image signal, read in the step S319 from the buffer memory 204, and a step S323 stores thus compressed image signal into the memory card 12.

133. After said recording, and after the completion of display of still image on the LCD monitor 115, the sequence proceeds to a step S324.

134. The step S324 causes the LCD monitor 115 to function as an electronic view finder for displaying a moving image. Then the sequence returns to the step S301 to await a next phototaking operation.

135. The above-explained adding circuit 210 adds the image signal from the selector switch 209 and various character information generated by the CPU 211, thereby displaying thus overlapped information on the LCD monitor 115. Said character information will be explained further in the following.

136. Data generally displayed in overlapping with the image are the warning for a low level of batteries (for the camera body, for back-up for time measurement, for the memory card etc.). This warning is displayed as long as the power supply is turned on. In addition, in overlapping with the still image displayed in the step S308, there are displayed a frame number, a data of phototaking, a message that the image is reproduced etc. Also in overlapping with the image of the view finder in the steps S313 and S324, there may be displayed frame number, remaining number of recordable frames, data of phototaking, message that the display is a moving image, white balance, warning for deficient light intensity, diaphragm aperture, shutter time, phototaking mode such as program mode, aperture preferential mode or shutter speed preferential mode, data compression rate, and/or warning for various errors resulting from the memory card. Also in overlapping with the display for confirming the phototaken image in the step S321, there may be displayed a message that the display is the phototaken image, warning for failed phototaking, warning for insufficient capacity of memory card, message indicating the completion of recording in the memory card.

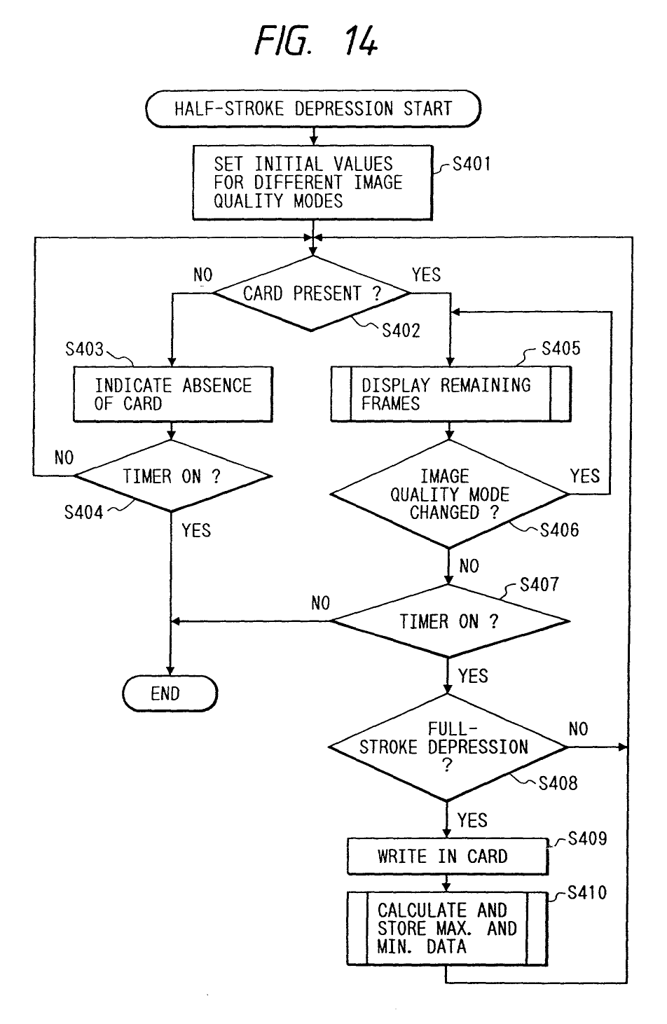

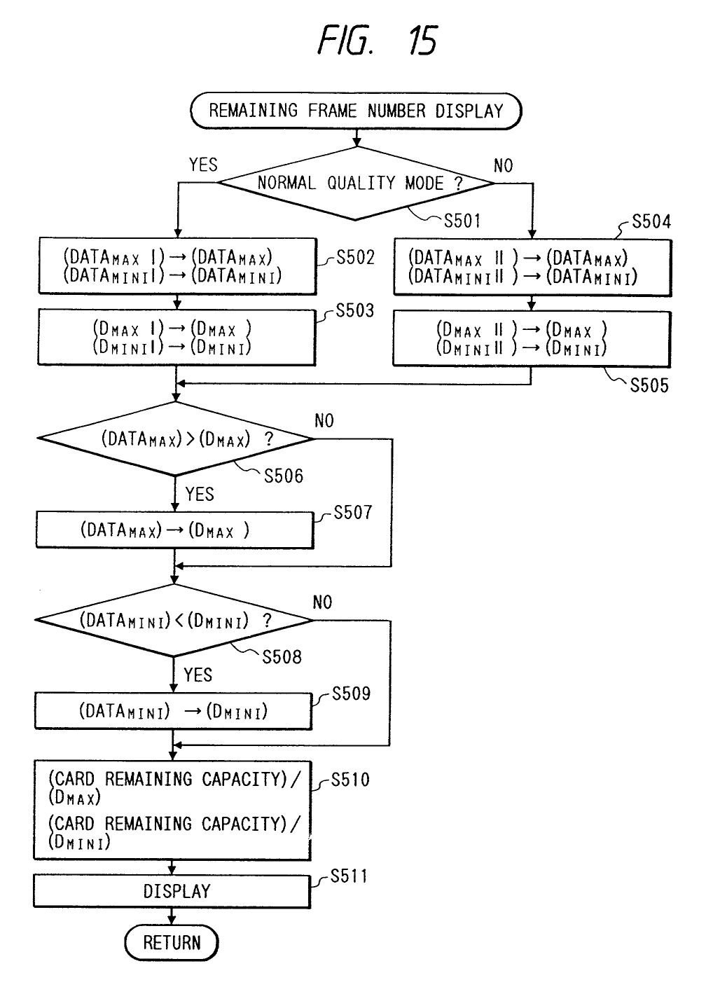

137. Among these, the display of the remaining number of recordable frames will be explained in the following, with reference to FIGS. 14 and 15.

138. At first reference is made to FIG. 14 for explaining the flow of display of the remaining number of recordable frames. It is assumed that the present camera is capable of selecting one of two modes of different compression rates, namely a normal image quality mode for compressing the image to about 1/10, and a low image quality mode for compressing the image to about 1/20.

139. The control sequence of the flow chart shown in FIG. 14 is initiated in response to the half-stroke depression of the shutter release button 16.

140. At frist a step S401 sets initial values of the maximum and minimum data amounts in respective image quality modes in predetermined registers. Said initial values are the approximate average values and the anticipated values stored in advance in an EEPROM or the like at the manufacture of the camera. The initial values for the maximum and minimum data amounts in the normal and low image quality modes are represented by MI, mI, MII and mII (suffixes I, II respectively indicating the normal and low image quality modes, and M, m standing respectively for the maximum and minimum data amounts in each mode), and the initial value setting registers are indicated by DMAX I, DMINI I, DMAX II and DMINI II. Also a parenthesized register name indicates the content thereof, for example (DMAX I)=MI. Also there are provided registers DATAMAX I, DATAMINI I, DATAMAX II and DATAMINI II for storing renewal data at each phototaking operation, into which the values of the initial value setting registers are set in the step S401. Thus the operations in the step S401 can be represented as follows:

141. (DMAX I)←MI

142. (DMINI I)←mI

143. (DMAX II)←MII

144. (DMINI II)←mII

145. (DATAMAX I)←(DMAX I)

146. (DATAMINI I)←(DMINI I)

147. (DATAMAX II)←(DMAX II)

148. (DATAMINI II)←(DMINI II)

149. After the initial settings in the step S401, the sequence proceeds to a step S402.

150. The step S402 discriminates whether the memory card 12 is present, and the sequence proceeds to a step S403 or S405 respectively if the memory card 12 is absent or present.

151. A step S403 displays the absence of the memory card on the LCD monitor 115.

152. A next step S404 discriminates whether the timer 213 is in function. During the function of the timer 213, the steps S402 to S404 are repeated, and, after the completion of function of the timer 213, the display for the absence of memory card, on the LCD monitor 115, is terminated.

153. On the other hand, in case the step S402 identifies the presence of the memory card 12, a step S405 displays the remaining number of recordable frames in the currently selected image quality mode on the LCD monitor 115, and the sequence proceeds to a step S406. The method of display of said remaining frame number will be explained later.

154. The step S406 discriminates whether the selected image quality mode has been changed, and, if changed, the sequence returns to the step S405 thereby displaying the remaining frame number in the newly selected image quality mode. If the mode has not been changed, the sequence proceeds to a step S407.

155. The step S407 discriminates whether the timer 213 is in function, and, if in function, the sequence proceeds to a step S408, but, if the timer function has been completed, the display of the remaining frame number on the LCD monitor 115 in terminated as in the step S404.

156. The step S408 discriminates whether the shutter release button 16 has been depressed over a full stroke, and, if depressed, the sequence proceeds to a next step S409. Since the memory card 12 may be extracted from the main body 11 during the function of the timer and prior to the full-stroke depression of the shutter release button 16, if the button 16 is not depressed, the sequence returns to the step S402 for repeating the steps S402 to S408.

157. In case the step S408 identifies the full-stroke depression of the shutter release button 16, a step S409 effects the exposure, A/D conversion, data compression and data storage in the memory card 12, as already explained in the flow chart shown in FIG. 13, and the sequence then proceeds to a step S410.

158. The step S410 calculates or detects the maximum or minimum data amount anew, and renews the settings of the registers DATAMAX I etc. for the data requiring renewal, and then the sequence returns to the step S402 for repeating the above-explained sequence. The operations in said step S410 will be explained more detailedly later.

159. In the following there will be explained the method of determination of the remaining number of recordable frames, for the display of said remaining frame number in the step S405, with reference to a flow chart shown in FIG. 15.

160. At first a step S501 discriminates whether the image quality mode is the normal image quality mode, and the sequence proceeds to a step S502 or S504, respectively if the normal or low image quality mode is selected.

161. The step S502 sets the maximum and minimum data amounts, respectively stored in the registers DATAMAX I, DATAMINI I for the normal image quality mode, respectively in other registers DATAMAX, DATAMINI.

162. A next step S503 sets the values of the initial value setting registers DMAX I, DMINI I respectively in other registers DMAX, DMINI, and the sequence proceeds to a step S506.

163. In case the step S501 identifies that the low image quality mode is selected, a step S504 sets the maximum and minimum data amounts, respectively stored in the registers DATAMAX II, DATAMINI II for the low image quality mode, respectively in other registers DATAMAX, DATAMINI.

164. A next step S505 sets the values of the initial value setting registers DMAX II, DMINI II respectively in other registers DMAX, DMINI, and the sequence proceeds to the step S506.

165. The step S506 discriminates whether the value of said DATAMAX is larger than that of DMAX, and, if larger or otherwise, the sequence respectively proceeds to a step S507 or S508.

166. The step S507 sets the value of the register DATAMAX into the register DMAX, and the sequence proceeds to the step S508.

167. The step S508 discriminates whether the value of the register DATAMINI is smaller than that of the register DMINI, and, if smaller or otherwise, the sequence respectively proceeds to a step S509 or S510.

168. The step S509 sets the value of DATAMINI in the register DMINI, and the sequence proceeds to the step S510.

169. The step S510 calculates the minimum and maximum remaining numbers of recordable frames, by dividing the remaining capacity of the memory card 12 respectively with the values of DMAX and DMINI and discarding the fractional part.

170. A next step S511 displays the minimum and maximum remaining numbers, determined in the step S510, on the LCD monitor 115, and the present sequence is thus terminated.

171. In the following there will be explained the method of determining the maximum or minimum data amount, in the step S410 in FIG. 14, with reference to FIGS. 16 to 21. The values obtained in this method can be used as the values in the above-mentioned registers DATAMAX I, DATAMINI I etc. In the following there are explained plural calculating methods as different embodiments, and the camera is preferably so constructed as to be capable of selecting plural methods according to the function of camera or the situation in which the camera is used.

172. FIG. 16 is a flow chart showing, as an 11th embodiment, a subroutine for determining the maximum or minimum data amount.

173. This embodiment calculates, at each phototaking operation, the average data amount NA on latest N frames and the standard deviation Nσ thereof, and uses NA+Nσ and NA−Nσ respectively as the maximum and minimum data amounts.

174. In the following the sequence of this subroutine will be explained step by step.

175. At first a step S601 discriminates whether the next phototaking operation is for the 1st frame in the currently used memory card. This is because the average calculation requires data of at least one frame. The sequence then proceeds to a step S602 or S606, respectively if the next phototaking operation is at least for the 2nd frame, or for the 1st frame.

176. The step S602 extracts the amount of compressed data of all the frames already recorded.

177. A next step S603 calculates, on the extracted amount of compressed data of all the frames, the average NA and the standard deviation Nσ.

178. A next step S604 calculates the maximum data amount by adding the standard deviation Nσ to the average NA, and the minimum data amount by subtracting said standard deviation Nσ from the average NA.

179. A next step S605 calculates the minimum and maximum remaining numbers of recordable frames by dividing the remaining capacity of the memory card respectively with said maximum and minimum data amounts, and the sequence then proceeds to a step S607.

180. On the other hand, in case the next phototaking operation is for the first frame, a step S606 calcualtes a value, as a substitute for the remaining frame number, by dividing the remaining capacity of the memory card with a predetermined initial value, and the sequence then proceeds to the step S607.

181. The step S607 discards the fractional part of the minimum and maximum remaining numbers of recordable frames, determined in the step S605, or the remaining frame number determined in the step S606, in order to obtain integral value(s) for display.

182. A next step S608 displays thus obtained integral value(s) on the display unit 115, as the remaining frame number, and the present subroutine is then terminated.

183. In said step S604, the maximum and minimum data amounts may naturally be calculated for example by NA± 2Nσ or NA±3Nσ.

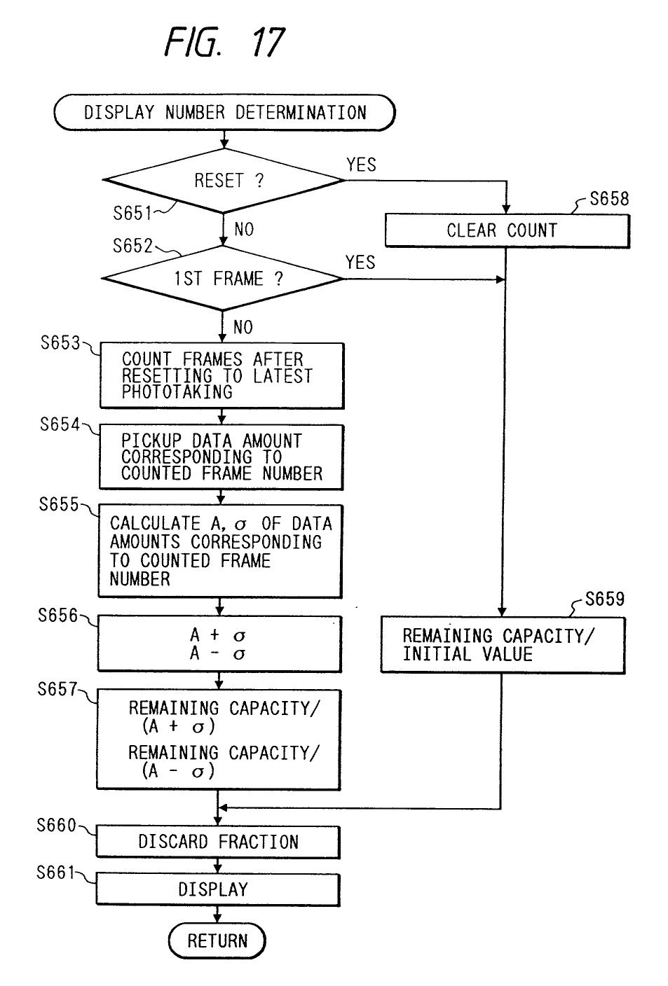

184. FIG. 17 is a flow chart showing, as a 12th embodiment, the method for calculating the maximum and minimum data amounts.

185. The present embodiment calculates, at each phototaking operation, the average A of the data amounts of the already recorded frames and the standard deviation a thereof, and the latest A±σ are taken as the maximum and minimum data amounts. The photographer can reset the average A at an arbitrary point, and the average is thereafter calculated anew. Said resetting can be achieved, for example, by two depressions of the selector button 18 within a predetermined period.

186. The sequence of the present subroutine will be explained in the following step by step.

187. At first a step S651 discriminates whether a resetting has been conducted, and the sequence proceeds to a step S658 or S652 respectively if the resetting has been conducted or not.

188. The step S652 discriminates whether the next phototaking operation is for the 1st frame after the latest resetting. This is because the average calculation requires data of at least one frame. Then the sequence proceeds to a step S653 or S659, respectively if the next phototaking operation is at least for the 2nd frame, or for the 1st frame.

189. The step S653 counts the number of frames recorded from the latest resetting to the latest phototaking operation. Said counting can be achieved by memorizing the number of recorded frames and adding one, at each phototaking operation, to the latest count.

190. A next step S654 extracts the amount of recorded compressed data, corresponding to thus counted frames.

191. A next step S655 calculates the average A of the compressed data amounts of the extracted frames and the standard deviation σ thereof.

192. A next step S656 calculates the maximum data amount by adding the standard deviation σ to the average A, and the minimum data amount by subtracting the standard deviation σ from the average A.

193. A next step S657 calculates the minimum and maximum remaining numbers of recordable frames by dividing the remaining capacity of the memory card respectively with the maximum and minimum data amounts, and then the sequence proceeds to a step S660.

194. In case the resetting has been conducted, a step S658 cancels the counting of recorded frames conducted in the immediately preceding step S653, and the seqeunce then proceeds to a step S659.

195. In case the counting is cancelled or in case the next phototaking operation is identified for the 1st frame, a step S659 calculates a value, as a substitute for the remaining frame number, by dividing the remaining capacity of the memory card with a predetermined initial value.

196. The sequence from a next step S660 is same as that starting from the step S607 in the 12th embodiment shown in FIG. 16.

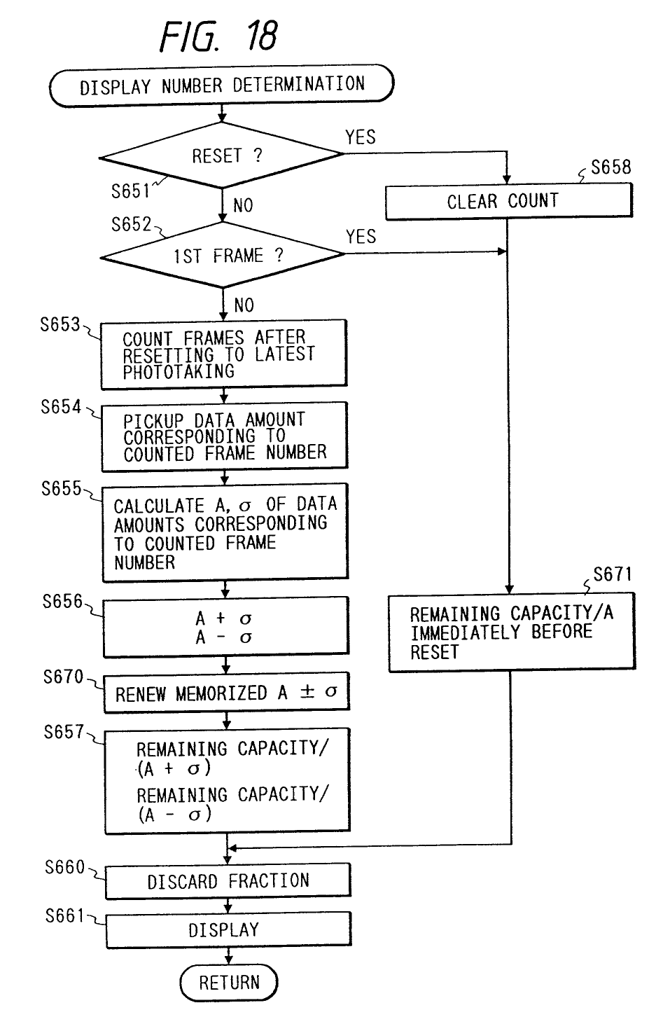

197. FIG. 18 is a flow chart showing, as a 13th embodiment, a subroutine for calculating the maximum and minimum data amounts.

198. In the present embodiment, the method of calculation of the maximum and minimum values and the resettable configuration are same as those in the 12th embodiment. Thus, steps same as those in the flow chart in FIG. 17 are represented by same numbers and will not be explained, and the following description will be devoted to steps S670 and S671, which are different from the 12th embodiment.

199. The step S671 renews the memory each time the maximum and minimum data amounts are calculated in the step S656.

200. In case the counting is cancelled or in case the next phototaking operation is identified for the frist frame, the sequence proceeds to the step S670, which calculates values, as substitutes for the remaining frame numbers, by dividing the remaining capacity of the memory card with the stored maximum and minimum data amounts immediately before the resetting.

201. In the 12th and 13th embodiments, the average value A may be reset each time the memory card is inserted into the main body 11 of the camera.

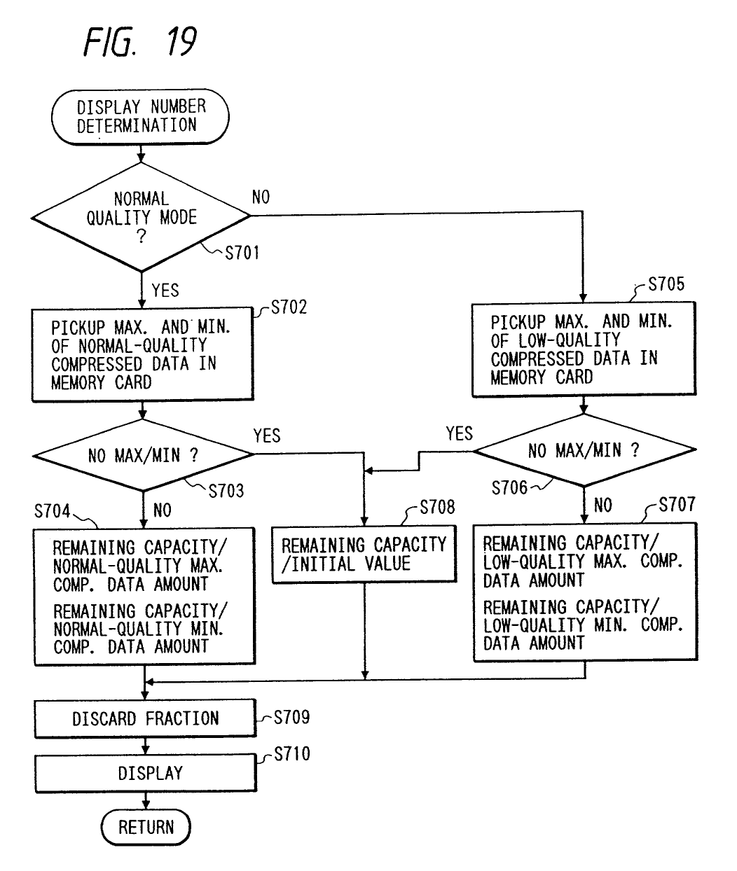

202. FIG. 19 is a flow chart showing, as a 14th embodiment, a subroutine for determining the maximum and minimum data amounts.

What is claimed is:

1. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
calculation means for determining the remaining number of recordable image frames by dividing the remaining capacity of the memory medium with the amount of compressed signal corresponding to an image frame; and
display means for displaying the number of already recorded image frames and said remaining number of recordable image frames.

2. An electronic still camera according to claim 1, further comprising:
selection means for selecting either simultaneous display of said number of recorded image frames and said remaining number of recordable image frames, or display of either one thereof, on said display means.

3. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
calculation means for determining the remaining number of recordable image frames by dividing the remaining capacity of the memory medium with the amount of compressed signal corresponding to an image frame; and
display switching means for selectively switching either the display of said remaining number of recordable image frames or the display of the remaining capacity of said memory medium.

4. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
calculation means for determining the remaining number of recordable image frames by dividing the remaining capacity of the memory medium with the amount of compressed signal corresponding to an image frame; and
display means consisting of a first display part for indicating the number of already recorded image frames and a second display part of a belt form positioned surrounding said first display part, and adapted to indicate the number of already recorded image frames and the remaining number of recordable image frames by lighting, in said second display part, only a range corresponding to said remaining number.

5. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting the amount of compressed signal of latest image frames of a predetermined number from said memory means;
calculation means for calculating the average data amount in the image frames of said predetermined number, and determining the remaining number of recordable image frames by dividing the remaining capacity of the memory medium with said average data amount or said average data amount increased by a predetermined proportion; and
display means for indicating said remaining number of recordable image frames.

6. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting, from said memory means, the amount of compressed signal of the image frames recorded in the memory medium;
calculation means for calculating the average data amount of thus extracted image frames and determining the remaining number of recordable image frames by dividing the remaining capacity of the memory medium with said average data amount or said average data amount increased by a predetermined proportion; and
display means for indicating said remaining number of recordable image frames.

7. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting the maximum data amount of latest compressed signal from said memory means;
calculation means for determining the remaining number of recordable image frames by dividing the remaining capacity of the memory medium with said maximum data amount; and
display means for displaying said remaining number of recordable image frames.

8. An electronic still camera capable of A/D conversion of still image signal obtained from an image pickup device and compression of the digitized signal, and provided with a memory medium capable of recording thus compressed signal plural times, comprising:
detection means for detecting the remaining capacity of the memory medium; and
calculation means for determining the remaining number of recordable image frames by dividing the remaining capacity of the memory medium with a predetermined data amount.

9. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
calculation means for determining the remaining number of recordable image frames by dividing the remaining capacity of the memory medium with the amount of said compressed signal in the latest phototaking operation; and
display means for indicating said remaining number of recordable image frames.

10. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting the maximum and minimum data amounts of compressed signals from said memory means;
calculation means for determining the minimum and maximum remaining numbers of recordable image frames by dividing the remaining capacity of the memory medium respectively with said maximum and minimum data amounts; and
display means for indicating said remaining number of recordable image frames in the form of a range defined by said minimum and maximum remaining numbers.

11. An electronic still camera according to claim 10, wherein said display means is adapted to indicate said range defined by the minimum and maximum remaining numbers of recordable image frames, with two integral numbers.

12. An electronic still camera according to claim 10, wherien said display means is adapted to indicate said range defined by the minimum and maximum remaining numbers of recordable image frames, by lighting a part of mutually adjacent display parts.

13. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting the image signals of the maximum amount, minimum amount and approximately average amount from said memory means;
calculation means for dividing the remaining capacity of the memory medium with said maximum, minimum and said approximately average amounts, thereby obtaining the respectively corresponding remaining numbers of recordable image frames;
selection means for manually selecting one of said compression signals of the maximum, minimum and approximately average amounts; and
display means for displaying thus selected compressed signal of said maximum, minimum or approximately average amount as a still image and also indicating said remaining number of recordable image frames, corresponding to said selected compressed signal.

14. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
extraction means for extracting the amount of compressed signal of latest image frames of a predetermined number, from said memory means;
calculation means for determining the minimum and maximum remaining numbers of recordable image frames, by calculating the average data amount in said image frames of predetermined number and the standard deviation thereof, and dividing the remaining capacity of the memory medium with said average data amount to which added is said standard deviation increased by a predetermined proportion, thereby determining the minimum remaining number of recordable image frames, and also dividing the remaining capacity of the memory medium with said average data amount from which subtracted is said standard deviation increased by a predetermined proportion, thereby determining the maximum remaining number of recordable image frames; and
display means for indicating at least either of said minimum and maximum remaining numbers of recordable image frames.

15. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
start signal input means for manually entering a start signal for initiating calculation of average;
extraction means for extracting, from said means, the amount of compression signal of the image frames after the entry of the calculation start signal by said start signal input means;
calculation means for calculating the average data amount in said image frames and determining the remaining number of recordable image frames by dividing the remaining capacity of the memory medium with said average data amount; and
display means for indicating said remaining number of recordable image frames.

16. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
start signal input means for manually entering a start signal for initiating calculation of average;
extraction means for extracting, from said memory means, the amount of compression signal of the image frames after the entry of the calculation start signal by said start signal input means;
calculation means for determining the minimum and maximum remaining numbers of recordable image frames, by calculating the average data amount in said image frames of predetermined number and the standard deviation thereof, and dividing the remaining capacity of the memory medium with said average data amount to which added is said standard deviation increased by a predetermined proportion, thereby determining the minimum remaining number of recordable image frames, and also dividing the remaining capacity of the memory medium with said average data amount from which subtracted is said standard deviation increased by a predetermined proportion, thereby determining the maximum remaining number of recordable image frames; and
display means for indicating at least either of said minimum and maximum remaining numbers of recordable image frames.

17. An electronic still camera according to claim 16, wherein said calculation means is adapted to determine the remaining number of recordable image frames by dividing said remaining capacity of the memory medium with a predetermined value, immediately after the manual entry of said calculation start signal and in case the phototaking operation has not taken place.

18. An electronic still camera according to claim 16, wherein said calculation means is adapted to determine the remaining number of recordable image frames by dividing said remaining capacity of the memory medium with an immediately preceding average value, immediately after the manual entry of said calculation start signal and in case the phototaking operation has not taken place.

19. An electronic still camera according to claim 16, wherein a mounting operation of the memory medium constitutes the manual operation, for entering said average calculation start signal, in said start signal input means.

20. An electronic still camera capable of A/D conversion of still image signal obtained from an image pickup device and compression of thus digitized signal, and provided with a memory medium capable of recording thus compressed signal plural times, comprising:
detection means for detecting the remaining capacity of the memory medium;
memory means for memorizing the amount of said compressed signal at each phototaking operation;
calculation means for determining the remaining number of recordable image frames by dividing the remaining capacity of the memory medium with a predetermined data amount until a predetermined number of image frames is reached, and, beyond said predetermined number, calculating the average data amount of the image frames recorded in the memory medium and the standard deviation thereof, and determining the minimum remaining number of recordable image frames by dividing the remaining capacity of the memory medium with said average data amount to which added is said standard deviation increased by a predetermined proportion, and the maximum remaining number of recordable image frames by dividing the remaining capacity of the memory medium with said average data amount from which subtracted is said standard deviation increased by a predetermined proportion; and
display means for indicating said remaining number of recordable image frames, or at least either of said minimum and maximum remaining numbers of recordable image frames.

21. An electronic still camera according to claim 20, wherein said predetermined frame number is determined, based on the remaining capacity of said memory medium detected by said detection means.

22. An electronic still camera according to claim 20, wherein said proportion of increase applied on said standard deviation in said calculation means beyond said predetermined number of image frames is a positive constant increasing with the number of recorded image frames.

23. An electronic still camera capable of A/D conversion of still image signal obtained from an image pickup device and compression of thus digitized signal, and provided with a memory medium capable of recording thus compressed signal plural times, comprising:
compression rate selection means for selecting one of plural compression rates with which said compression of the digitized signal can be conducted;
detection means for detecting the remaining capacity of the memory medium;
memory means for memorizing the amount of said compressed signal and the compression rate thereof for each phototaking operation;
extraction means for extracting, from said memory means, the maximum and minimum amounts of the compressed signal for each compression rate;
calculation means for determining the minimum and maximum remaining numbers of recordable image frames for each compression rate, by dividing the remaining capacity of the memory medium with said maximum data amounts thereby determining the minimum remaining numbers of recordable image frames for the resepctive compression rates, and by dividing the remaining capacity of the memory medium with said minimum data amounts thereby determining the maximum remaining numbers of recordable image frames for the respective compression rates; and
display means for indicating the remaining number of recordable image frames in the form of a range defined by the minimum and maximum remaining numbers of recordable image frames for the currently selected compression rate.

24. An electronic still camera according to claim 23, wherein said compression rate selection means is adapted to automatically vary the compression rate when said detection means detects that the remaining capacity of the memory medium has become equal to or less than a predetermined value, and said display means is adapted to indicate the remaining number of recordable image frames with a range based on thus varied compression rate.

25. An electronic still camera capable of A/D conversion of still image signal obtained from an image pickup device and compression of thus digitized signal, and provided with a memory medium capable of recording thus compressed signal plural times, comprising:
compression rate selection means for selecting one of plural compression rates with which said compression of the digitized signal can be conducted;
detection means for detecting the remaining capacity of the memory medium;
memory means for memorizing the amount of said compressed signal and the compression rate thereof for each phototaking operation;
extraction means for extracting, from said memory means, the maximum and minimum amounts of the compressed signal for each compression rate;
calculation means for determining the minimum and maximum remaining numbers of recordable image frames for each compression rate, by dividing the remaining capacity of the memory medium with said maximum data amounts thereby determining the minimum remaining numbers of recordable image frames for the respective compression rates, and by dividing the remaining capacity of the memory medium with said minimum data amounts thereby determining the maximum remaining numbers of recordable image frames for the respective compression rates; and
display means for indicating at least either of the minimum and maximum remaining numbers of recordable image frames for the currently selected compression rate.

26. An electronic still camera according to claim 25, wherein said compression rate selection means is adapted to automatically vary the compression rate when said detection means detects that the remaining capacity of the memory medium has become equal to or less than a predetermined value, and said display means is adapted to indicate the remaining number of recordable image frames with a range based on thus varied compression rate.
